(19) United States
(12) Patent Application Publication
(10) Pub. No.: US 2025/0200141 A1
(43) Pub. Date: Jun. 19, 2025

(54) POOLING CALCULATION DEVICE AND POOLING CALCULATION METHOD

(71) Applicant: SigmaStar Technology Ltd., Xiamen (CN)

(72) Inventors: Donghao LIU, Shanghai (CN); Wei ZHU, Shanghai (CN); Bo LIN, Shanghai (CN)

(21) Appl. No.: 18/951,763

(22) Filed: Nov. 19, 2024

(30) Foreign Application Priority Data
Dec. 14, 2023 (CN) 202311728947.X

(51) Int. Cl. G06F 17/18

(52) U.S. Cl. CPC G06F 17/18

(57) ABSTRACT

A pooling calculation device operable to perform a pooling operation on a data matrix with multiple channels includes an internal memory, a pooling calculation circuit and multiple registers. The internal memory stores at least part of data of the data matrix. The pooling calculation circuit reads multiple sets of data corresponding to a matching number of channels, and simultaneously performs a pooling process on the data corresponding to the matching number of channels to generate multiple sets of pooling data corresponding to the matching number of channels. The multiple registers respectively correspond to the matching number of channels, and respectively store multiple sets of intermediate data for the pooling process of the data corresponding to the matching number of channels. The matching number of channels are determined according to a bandwidth of the internal memory, and the matching number is a positive integer greater than or equal to 2.

This application claims the benefit of China application Serial No. CN202311728947.X, filed on Dec. 14, 2023, the subject matter of which is incorporated herein by reference.

### BACKGROUND OF THE INVENTION

### Field of the Invention

The present application relates to a pooling calculation device and a pooling calculation method, and more particularly to a pooling calculation device and a pooling calculation method simultaneously processing data of multiple channels.

### Description of the Related Art

In neural network calculations, a pooling operation is one of the common operators. A common pooling operation includes max pooling and average pooling. According to different strides and filter sizes needed, the pooling operation can compress information of a required region into a value so as to achieve the object of down-sampling.

However, in a scenario where a central processing unit (CPU) executes such conventional pooling operation, the processing speed of the CPU for each cycle is limited, and data storage of pooling demands special requirements—these conditions lead to a failure of the neural network in terms of satisfying performance requirements for pooling calculation.

### SUMMARY OF THE INVENTION

In view of the drawbacks of the prior art, it is an object (for example but not limited to) of the present application to provide a pooling calculation device and a pooling calculation method so as to improve the prior art.

A pooling calculation device operable to perform a pooling operation on a data matrix with multiple channels includes an internal memory, a pooling calculation circuit and multiple registers. The internal memory stores at least part of data of the data matrix. The pooling calculation circuit reads multiple sets of data corresponding to a matching number of channels, and simultaneously performs a pooling process on the multiple sets of data corresponding to the matching number of channels to generate multiple sets of pooling data corresponding to the matching number of channels. The multiple registers respectively correspond to the matching number of channels, and respectively store multiple sets of intermediate data for the pooling process of the multiple sets of data corresponding to the matching number of channels. The matching number of channels are determined according to a bandwidth of the internal memory, and the matching number is a positive integer greater than or equal to 2.

In some embodiments, the pooling calculation method is operable to perform a pooling calculation on a data matrix with multiple channels and is applied to an integrated circuit, which includes an internal memory and a pooling calculation device. The pooling calculation method includes: storing at least part of data of the data matrix to the internal memory; and reading multiple sets of data corresponding to a matching number of channels from the internal memory by the pooling calculation device, and simultaneously performing a pooling operation on the data corresponding to the matching number of channels by the pooling calculation device to generate multiple sets of pooling data corresponding to the matching number of channels, wherein the matching number of channels are determined according to a bandwidth of the internal memory, and the matching number is a positive integer greater than or equal to 2.

The pooling calculation device and the pooling calculation method of the present application are capable of simultaneously processing data of multiple channels, and the number of the multiple channels matches with a bandwidth of the internal memory. Thus, data read each time by the pooling calculation device of the present application is valid data, so that the bandwidth pressure can be eased in addition to enhancing the utilization rate of data transmission.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an integrated circuit and an external dynamic random access memory (DRAM) according to some embodiments of the present application;

FIG. 2 is a schematic diagram of a pooling calculation device according to some embodiments of the present application;

FIG. 3 is a schematic diagram of a data matrix with multiple channels according to some embodiments of the present application;

FIG. 4 is a schematic diagram of a pooling calculation device according to some embodiments of the present application;

FIG. 5 is a schematic diagram of an operation of an average calculation circuit according to some embodiments of the present application;

FIG. 6 is a schematic diagram of an operation of an average calculation circuit according to some embodiments of the present application;

FIG. 7 is a schematic diagram of an operation of an average calculation circuit according to some embodiments of the present application;

FIG. 8 is a schematic diagram of an operation of an average calculation circuit according to some embodiments of the present application;

FIG. 9 is a schematic diagram of an operation of an average calculation circuit according to some embodiments of the present application;

FIG. 10 is a schematic diagram of an operation of an average calculation circuit according to some embodiments of the present application;

FIG. 11 is a schematic diagram of an operation of an average calculation circuit according to some embodiments of the present application; and

FIG. 12 is a flowchart of a pooling calculation method according to some embodiments of the present application.

### DETAILED DESCRIPTION OF THE INVENTION

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

To resolve the issues encountered during a pooling operation performed by a central processing unit in the prior art, the present application provides a pooling calculation device operable to simultaneously process data of multiple channels, with details as given in the description below.

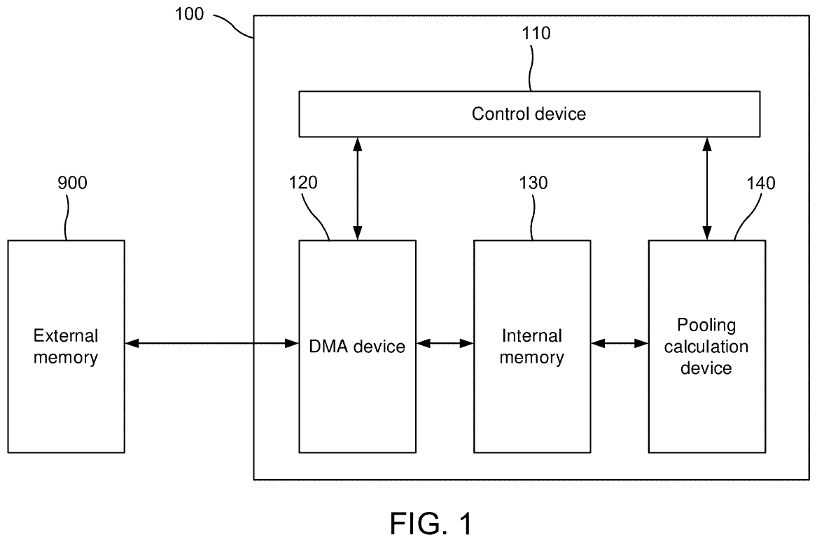

FIG. 1 shows a schematic diagram of an integrated circuit 100 and an external memory 900 according to some embodiments of the present application. As shown in the drawing, the integrated circuit 100 includes a control device 110, a direct memory access (DMA) device 120, an internal memory 130 and a pooling calculation device 140.

In some embodiments, the control device 110 receives a control signal from an external processor, and transmits the control signal to the DMA device 120 and the pooling calculation device 140. The DMA device 120 transmits data from the external memory 900 to the internal memory 130 according to the control signal. Next, the pooling calculation device 140 operates collaboratively with the internal memory 130 according to the control signal so as to complete the pooling calculation. Then, the DMA device 120 transmits the data back to the external memory 900.

In some embodiments, the external memory 900 may be a dynamic random access memory (DRAM). The integrated circuit 100 may be an application-specific integrated circuit (ASIC). The control device 110 may be a control unit. The DMA device 120 may be a DMA circuit. The internal memory 130 may be a static random access memory (SRAM). The pooling calculation device 140 may be an arithmetic logic unit (ALU).

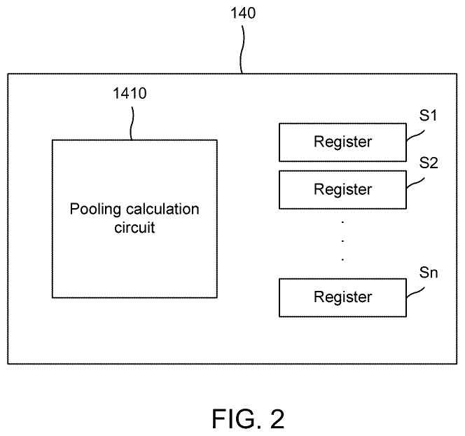

FIG. 2 shows a schematic diagram of the pooling calculation device 140 according to some embodiments of the present application. As shown in the drawings, the pooling calculation device 140 includes a pooling calculation circuit 1410 and multiple registers S1 to Sn. Since the bandwidth of the internal memory 130 in FIG. 1 is limited, in order to efficiently utilize the bandwidth and to prevent degraded effective utilization rate of the bandwidth caused by reading invalid data, the present application determines, according to the bandwidth of the internal memory 130, how many channels corresponding to multiple sets of data to read by the pooling calculation circuit 1410. In other words, the pooling calculation circuit 1410 matches the number of channels with the bandwidth of the internal memory 130, so that the pooling calculation circuit 140 simultaneously reads data of a matching number of channels. In some embodiments, the pooling calculation circuit 1410 at least simultaneously reads multiple sets of data of two or more channels, and thus the matching number above is at least 2.

The multiple registers S1 to Sn respectively correspond to the matching number of channels, and store multiple sets of intermediate data generated during a pooling calculation process. For example, if the matching number of channels is 8, at least 8 corresponding registers, or registers in a multiple of 8, are needed.

The pooling calculation circuit 1410 simultaneously performs a pooling process on the multiple sets of data received from different channels so as to generate multiple sets of pooling data corresponding to the different channels. For example, if the matching number of channels is 8, the pooling calculation circuit 1410 simultaneously and in parallel performs the pooling process on the data of these 8 channels. In other words, the data in each of the 8 channels undergoes a separate pooling process, and thus one set of pooling data is generated for each of the 8 channels to yield a total of 8 sets of pooling data. In conclusion, the pooling calculation device 140 of the present application is capable of simultaneously and in parallel processing data of multiple channels, and the number of the multiple channels matches with the bandwidth of the internal memory 130. Thus, data read each time by the pooling calculation device 140 of the present application is valid data, thereby enhancing the utilization rate of data transmission and further easing the bandwidth pressure.

In some embodiments, the matching number of channels is inversely proportional to a data bit of each set of data. For example, due to the limited bandwidth of the internal memory 130 in FIG. 1, assuming that the data bit of each set of data is large, the matching number of channel is then small. Conversely, the matching number is large if the data bit is small. More specifically, assuming that the bandwidth of the internal memory 130 is fixed at 128 bits, the pooling calculation device 140 can read data via only 8 channels at the same time if the data bit of data is 16 bits. In contrast, the pooling calculation device 140 can read data via 16 channels at the same time if the data bit of data is 8 bits.

In some embodiments, a product of the matching number of channels and the data bit of each set of data is equal to a bandwidth size value of the bandwidth. For example, assuming that the bandwidth of the internal memory 130 is 128 bits, the matching number of channels is 8 if the data is 16 bits, and the product of the data bit of each set of data and the matching number of channels is 128. In another example, assuming that the bandwidth of the internal memory 130 in 128 bits, the matching number of channels is 16 if the data is 8 bits, and the product of the data bit of each set of data and the matching number of channels is still equal to the bandwidth size value, which is 128.

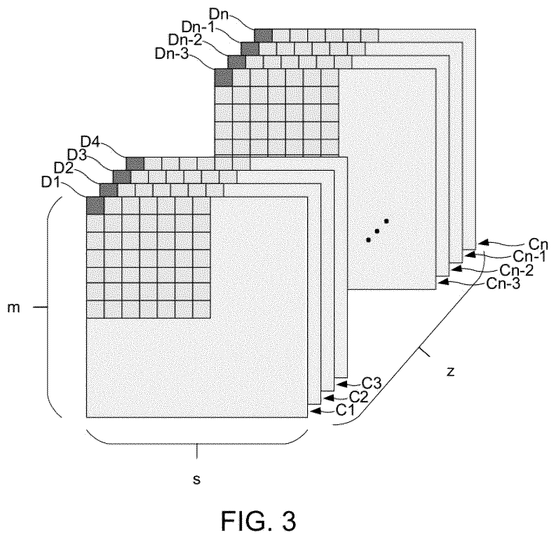

FIG. 3 shows a schematic diagram of a data matrix with multiple channels according to some embodiments of the present application. As shown in FIG. 3, data needs pooling is a data matrix with multiple channels. The data matrix is usually stored in the external memory 900. When the pooling calculation device 140 performs a pooling calculation, the control device 110 controls the DMA device 120 according to a progress of the pooling calculation to sequentially read data to be processed in the data matrix from the external memory 900 to the internal memory 130, and then the pooling calculation device 140 reads the data to be processed from the internal memory 130. In general, the storage space of the internal memory 130 can store only part of the data of the data matrix. A conventional pooling operation reads data D1 via only one single channel C1, and performs a pooling calculation on the data D1 to obtain pooling data. In comparison, the pooling calculation device 140 of the present application is capable of simultaneously performing a pooling process on the multiple sets of data of multiple channels among the channels C1 to Cn.

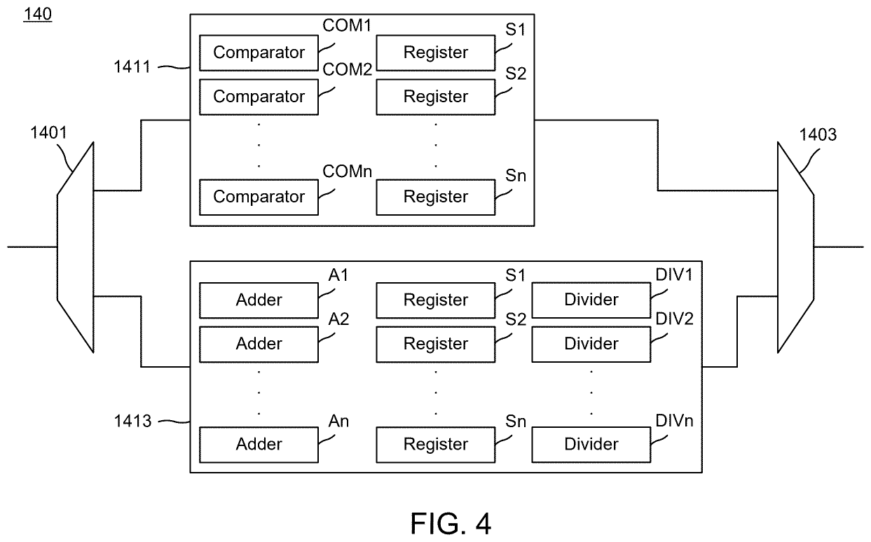

To better understand the operation details of the pooling calculation device 140 of the present application, please also refer to FIG. 4, which shows a circuit block diagram of the pooling calculation device 140 according to some embodiments of the present application. As shown in the drawing, the pooling calculation device 140 includes a selection circuit 1401, a maximum calculation circuit 1411, an average calculation circuit 1413 and a selection circuit 1403.

In some embodiments, the selection circuit 1401 determines, according to a selection signal, whether to select the maximum calculation circuit 1411 or the average calculation circuit 1413 to perform the pooling process on multiple sets of data D1 to Dn. Moreover, the selection circuit 1403 correspondingly performs the same selection as the selection circuit 1401, so as to output calculated pooling data.

If the maximum calculation circuit 1411 is selected to perform the pooling process on the multiple sets of data D1 to Dn, the maximum calculation circuit 1411 simultaneously compares the multiple sets of data D1 to Dn of different channels C1 to Cn to generate multiple sets of maximum data as multiple sets of pooling data. For example, the maximum calculation circuit 1411 may compare the data D1 of the first channel C1 to generate pooling data, and simultaneously compare the data D2 of the second channel C2 to generate pooling data, and so forth.

Similarly, if the average calculation circuit 1413 is selected to perform the pooling process on the multiple sets of data D1 to Dn, the average calculation circuit 1413 simultaneously adds the multiple sets of data D1 to Dn of the different channels C1 to Cn to generate multiple sets of addition data, and simultaneously performs a division on the multiple sets of addition data of the different channels C1 to Cn to generate multiple sets of pooling data. For example, the average calculation circuit 1413 may add the data D1 of the first channel C1 to generate first addition data, and simultaneously add the data D2 of the second channel C2 to generate second addition data, and so forth. Then, the average calculation circuit 1413 may perform an average calculation on the first addition data of the first channel C1 to generate pooling data, and simultaneously perform an average calculation on the second addition data of the second channel C2 to generate pooling data, and so forth.

Referring to FIG. 4, in some embodiments, the average calculation circuit 1413 includes multiple adders A1 to An, multiple registers S1 to Sn and multiple dividers DIV1 to DIVn. The multiple adders A1 to An may simultaneously perform addition on the multiple sets of data D1 to Dn received by the different channels C1 to Cn to generate multiple sets of addition data, respectively, and store the multiple sets of addition data to the multiple registers S1 to Sn; that is to say, the registers S1 to Sn are operable to store intermediate data generated during the pooling calculation process, for example, the multiple sets of addition data in this example. The multiple dividers DIV1 to DIVn simultaneously perform a division on the multiple addition data of the different channels C1 to Cn to generate multiple sets of pooling data.

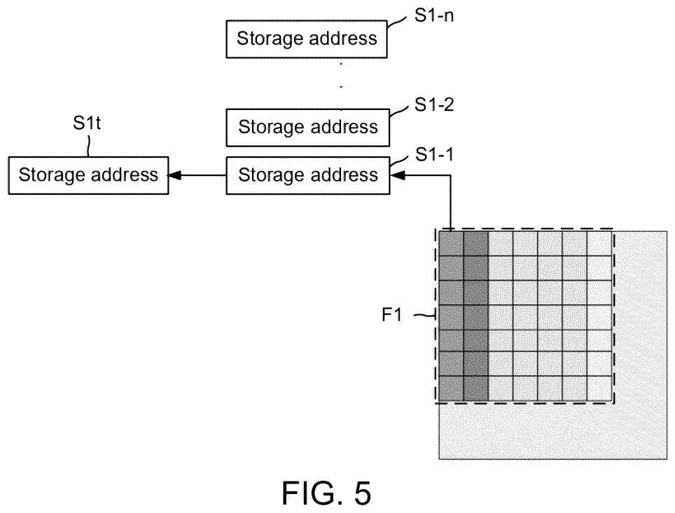

Refer to FIG. 5 to better understand the operation of the average calculation circuit 1413. In this example, the register S1 includes n+1 storage addresses, more specifically, storage addresses S1-1 to S1-n and a storage address S1t. During a first period, the first adder A1 among the multiple adders A1 to An of the average calculation circuit 1413 adds data of the first column of the first channel C1 among the channels C1 to Cn to obtain addition data of the first column, and stores the addition data of the first column to the storage address S1-1 of the register S1. Moreover, the storage address S1t of the register S1 is used to store addition data of the individual columns of the first channel C1 as total addition data, and at this point, the storage address S1t stores only the addition data of the first column of the first channel C1.

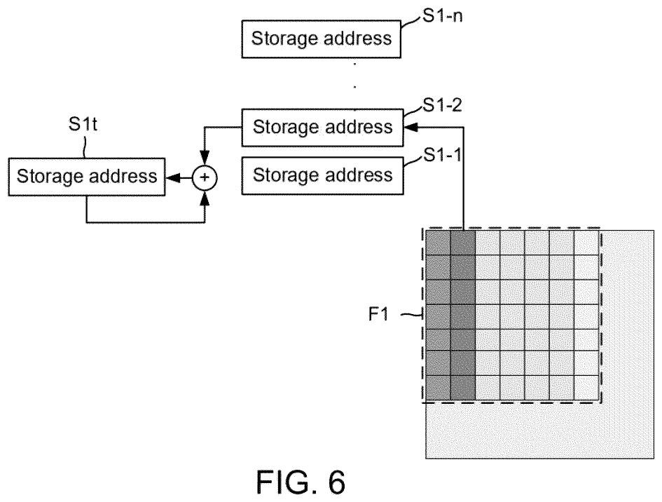

Next, referring to FIG. 6, during a second period, the first adder A1 adds data of the second column of the first channel C1 to obtain addition data of the second column, and stores the addition data of the second column to the storage address S1-2 of the register S1. Moreover, the addition data of the first column stored in the storage address S1t is added with the addition data of the second column in the storage address S1-2 to obtain total addition data.

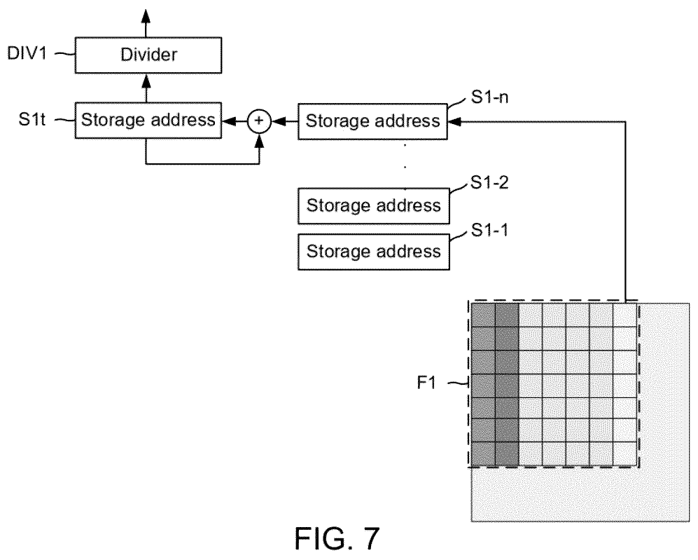

The steps above are continued, and in an nth period, as shown in FIG. 7, the first adder A1 adds data of the nth column of the first channel C1 to obtain addition data of the nth column, and stores the addition data of the nth column to the storage address S1-n of the register S1. Moreover, all of the addition data stored in the storage address S1t is further added with the addition data of the nth column in the storage address S1-n to obtain new total addition data.

Once the total addition data is obtained after the first adder A1 completes the addition for the data of all the columns in a window F1, the first divider DIV1 among the dividers DIV1 to DIVn performs an average calculation on the total addition data stored in the storage address S1t to obtain first-channel pooling data C1.

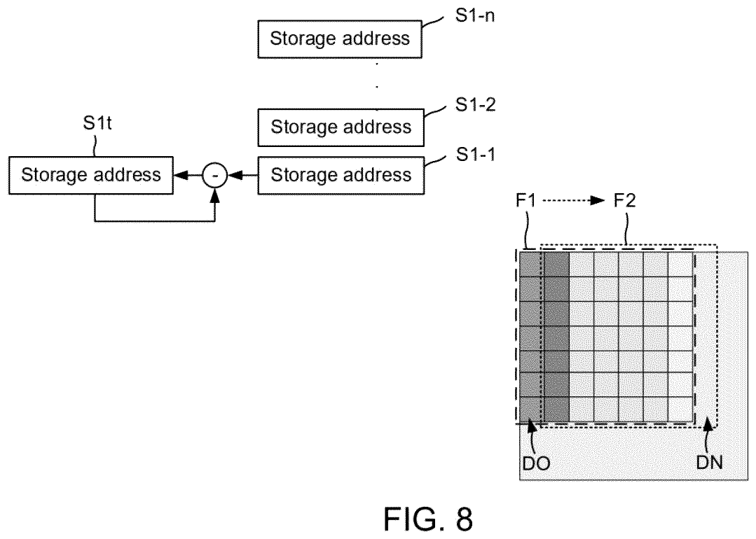

As shown in FIG. 5 to FIG. 7, the average calculation circuit 1413 has performed the average calculation on the total addition data within the window F1 to obtain the pooling data of the first channel C1. Then, according to a predetermined stride of the present application, the window F1 moves to a window F2 in FIG. 8. At this point, as shown in the drawing, an overlapping region between the window F1 and the window F2 is substantially unchanged. In order to prevent repeated calculation on data of the overlapping region, the data of the overlapping region is basically not calculated again; more specifically, old data DO not included in the window F2 is deducted, and new data DN on the right of the window F2 is added.

In FIG. 8, the window F1 has moved to the window F2. At this point, the average calculation circuit 1413 first deducts the old data DO originally stored in the storage address S1-1 from the total addition data stored in the storage address S1t, and stores the total addition data of the overlapping region to the storage address S1t of the register S1.

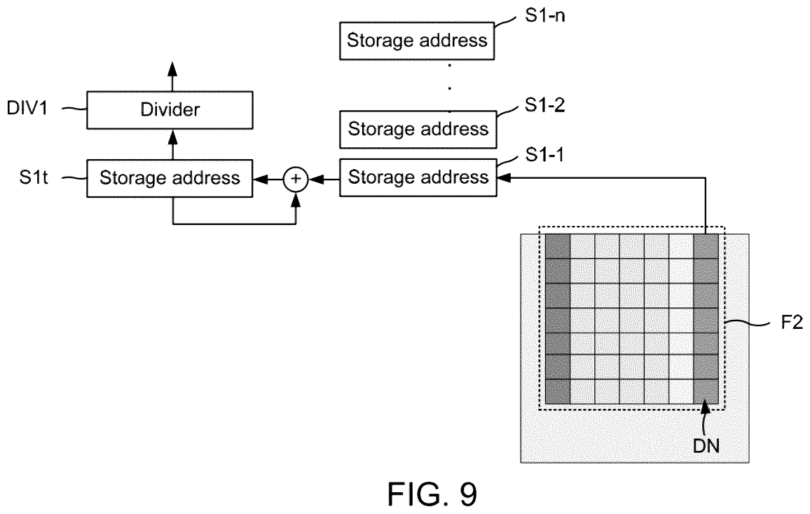

Referring to FIG. 9, in continuation of the above, the average calculation circuit 1413 still needs to add the new data DN on the right of the window F2. At this point, because the old data DO originally stored in the storage address S1-1 of the register S1 is no longer needed, the average calculation circuit 1413 may then store the addition data to the storage address S1-1 after calculating the addition data of the new data DN. Because the storage address S1t has the data of the overlapping region between the window F1 and the window F2 stored therein, the average calculation circuit 1413 only needs to add the addition data of the new data DN in the storage address S1-1 to the total addition data of the overlapping region stored in the storage address S1t to obtain total addition data of the window F2. With the aforementioned operations, the present application is capable of preventing repeated calculation of data of the overlapping region, hence reducing the amount of calculation and further effectively enhancing the performance of the pooling calculation device 140 of the present application.

In some embodiments, the processing means performed by the average calculation circuit 1413 on the data of the second channel C2 to the nth channel Cn is similar to the processing means of the data performed by the average calculation circuit 1413 on the data of the first channel C1 in FIG. 5 to FIG. 7, and such repeated details are omitted herein.

In some embodiments, the calculation means of the maximum calculation circuit 1411 is similar to that of the average calculation circuit 1413, with associated details as given in the description below. Referring to FIG. 4, the maximum calculation circuit 1411 includes multiple comparators COM1 to COMn and multiple registers S1 to Sn. In practice, the comparators COM1 to COMn can share the same registers S1 to Sn with the adders A1 to An. During a first period, the first comparator COM1 among the multiple comparators COM1 to COMn compares the data of the first column of the first channel C1 among the channels C1 to Cn to obtain first maximum data, and stores the first maximum data to the register S1. Similarly, the second comparator COM2 compares the data of the second column of the second channel C2 to obtain maximum data, and stores the maximum data to the register S2, and so forth. That is, the multiple comparators COM1 to COMn simultaneously process the channels C1 to Cn.

Next, during a second period, the first comparator COM1 compares the data of the second column of the first channel C1 to obtain second maximum data, and stores the second maximum data to the register S1.

Assuming that a window is a 2×2 window, respective maximum data of two columns is obtained by the comparison operation above. Next, the first comparator COM1 compares the first maximum data and the second maximum data to obtain pooling data of the first channel C1.

In some embodiments, the processing means performed by the maximum calculation circuit 1411 on the data of the second channel C2 to the nth channel Cn is similar to the processing means performed by the maximum calculation circuit 1411 on the data of the first channel C1, and such repeated details are omitted herein.

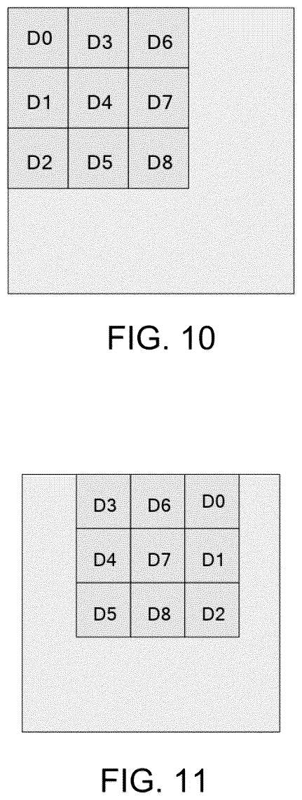

In some embodiments, referring to FIG. 10, it is assumed that the window is 3×3, the stride is 1, the data bit is 16 bits, the number of channels is 8, and the bandwidth of the internal memory 130 is 128 bits. In this example, due to the limitation of the bandwidth of the internal memory 130, the processes of adding and/or comparing the maximum value of the data of one column of the corresponding window cannot be completed in a one-time operation. Thus, the data of each column is processed in sections so as to complete the processes of adding and/or comparing the maximum value of the data of each column. An average pooling process is given as an example below. First of all, data in the internal memory 130 is read and denoted as D0, which includes data at positions corresponding to 8 channels. Next, data in the internal memory 130 is read and denoted as D1, which also includes data at positions corresponding to 8 channels. The data D0 and the data D1 are divided into 8 groups and added according to corresponding channels.

Next, data in the internal memory 130 is read and denoted as D2, which also includes data at positions corresponding to 8 channels. Addition results of the data D2, the data D0 and the data D1 are added according to the corresponding channels to complete an addition operation of the data D0 to D2 of the first column, and the results are stored to the registers S1 to S8 corresponding to the channels, wherein this set of results can be denoted as a result R0.

The addition operations of the data D3 to D5 and the data D6 to D8 are sequentially completed. Addition results of the data D3 to D5 are stored to the registers S1 to S8 corresponding to the channels, wherein this set of results can be denoted as a result R1. Addition results of the data D6 to D8 are stored to the registers S1 to S8 corresponding to the channels, wherein this set of results can be denoted as a result R2. The results R0 to R2 stored in the registers S1 to S8 are the intermediate data during the pooling calculation process. Then, an average operation is performed for the results R0 to R2 to obtain an output of the first window.

Next, referring to FIG. 11, the window is moved to the right by 1 stride to a new position, wherein the data D0 to D2 are new data not yet calculated during the calculation of the first window, and so the new data is read from the internal memory 130 and denoted as data D0. The new data is read from the internal memory 130 and denoted as data D1. The data D0 and the data D1 are divided into 8 groups and added in a unit of 16 bits.

Next, the new data is read from the internal memory 130 and denoted as data D2. Addition results of the data D2, the data D0 and the data D1 are added to complete the addition operation of the data D0 to D2 of the first column. The results are updated to the corresponding registers S1 to S8 of the channels, wherein this set of results can be denoted as a result R0. At this point, the data of the result R0 is updated.

Then, an average operation is performed for the results R0 to R2 to obtain an output of the second window. During the calculation process of the second window, the data D3 to D8 is not read again, and instead, the results R1 and R2 in the registers are used to perform the average operation. Thus, the present application is capable of preventing repeated calculation of data of an overlapping region, hence reducing the amount of calculation and further effectively enhancing the performance of the pooling calculation device 140 of the present application.

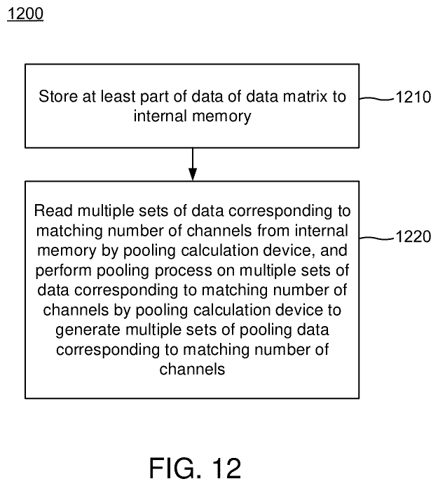

FIG. 12 shows a flowchart of a pooling calculation method 1200 according to some embodiments of the present application. As shown in FIG. 12, the pooling calculation method 1200 is operable to perform a pooling calculation on a data matrix with multiple channels. The pooling calculation method 1200 is applied to the integrated circuit 100 in FIG. 1. The pooling calculation method 1200 includes steps 1210 and 1220, with details as given in the description below.

In FIG. 1 and FIG. 12, in step 1210, at least part of data of the data matrix is stored to the internal memory 130. For example, the control device 110 controls the DMA device 120 according to the progress of the pooling calculation to sequentially transmit the data to be processed in the data matrix to the internal memory 130, so as to store at least part of the data of the data matrix to the internal memory 130.

In step 1220, multiple sets of data corresponding to a matching number of channels is read from the internal memory 130 by the pooling calculation circuit 140, and a pooling process is simultaneously performed on the multiple sets of data corresponding to the matching number of channels by the the pooling calculation circuit 140 to generate multiple sets of pooling data corresponding to the matching number of channels. The matching number of channels are determined according to a bandwidth of the internal memory 130, and the matching number is a positive integer greater than or equal to 2.

For example, referring to FIG. 2, if the matching number of channels is 2 or more, the pooling calculation circuit 1410 of the pooling calculation device 140 simultaneously and in parallel performs the pooling process on the data of these 2 or more channels. In other words, the data in each of the 2 or more channels undergoes a separate pooling process, and thus one set of pooling data is generated for each of the 2 or more channels. In conclusion, the pooling calculation method 1200 of the present application is capable of simultaneously and in parallel processing data of multiple channels by using the pooling calculation device 140, and the number of the multiple channels matches with the bandwidth of the internal memory 130. Thus, data read each time by the pooling calculation method 1200 of the present application is valid data, thereby enhancing the utilization rate of data transmission and further easing the bandwidth pressure.

It should be noted that, the present application is not limited to the embodiments shown in FIG. 1 to FIG. 12, and are merely examples of implementations of the present application for the purpose of better understanding the technical contents of the present application. The scope of protection of the present application is to be accorded with the broadest interpretation of the appended claims. Without departing from the spirit of the present application, all modifications and variations made to the embodiments of the present application by a person skilled in the art are to be encompassed within the scope of protection of the present application.

In conclusion, the pooling calculation device and the pooling calculation method of the present application are capable of simultaneously processing data of multiple channels, and the number of the multiple channels matches with a bandwidth of the internal memory. Thus, data read each time by the pooling calculation device of the present application is valid data, so that the bandwidth pressure can be eased in addition to enhancing the utilization rate of data transmission.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A pooling calculation device, operable to perform a pooling operation on a data matrix with a plurality of channels, the device comprising:
an internal memory, storing at least part of data of the data matrix;
a pooling calculation circuit, reading a plurality of sets of data corresponding to a matching number of channels, and simultaneously performing a pooling process on the plurality of sets of data corresponding to the matching number of channels to generate a plurality of sets of pooling data corresponding to the matching number of channels; and
a plurality of registers, respectively corresponding to the matching number of channels, and respectively storing a plurality of sets of intermediate data for the pooling process of the plurality of sets of data corresponding to the matching number of channels;
wherein the matching number of channels are determined according to a bandwidth of the internal memory, and the matching number is a positive integer greater than or equal to 2.

2. The pooling calculation device according to claim 1, wherein a product of the matching number and a data bit of each of the plurality sets of data corresponding to the matching number of channels is equal to a bandwidth of the bandwidth.

3. The pooling calculation device according to claim 1, wherein the pooling calculation circuit comprises an average calculation circuit comprising:
a plurality of adders, simultaneously performing an addition on the plurality of sets of data respectively corresponding to the matching number of channels to generate a plurality of sets of addition data, and storing the plurality of sets of addition data to the registers;
a plurality of dividers, simultaneously performing a division on the plurality of sets of addition data corresponding to the matching number of channels to generate the plurality of sets of pooling data.

4. The pooling calculation device according to claim 3, wherein a first adder among the adders adds a first set of data corresponding to a first channel among the channels in a first period to obtain a first set of addition data;
wherein the first adder among the adders adds a second set of data corresponding to the first channel in a second period to obtain a second set of addition data; and
wherein a first divider among the dividers performs an average calculation on the first set of addition data and the second set of addition data to obtain first-channel pooling data in the plurality of sets of pooling data.

5. The pooling calculation device according to claim 1, wherein the pooling calculation circuit comprises a maximum calculation circuit comprising:
a plurality of comparators, simultaneously comparing the plurality of sets of data corresponding to the matching number of channels to generate a plurality of sets of maximum data as the plurality of sets of pooling data.

6. The pooling calculation device according to claim 1, wherein the pooling calculation circuit comprises:
a maximum calculation circuit, simultaneously comparing the plurality of sets of data corresponding to the matching number of channels to generate a plurality of sets of maximum data as the plurality of sets of pooling data;
an average calculation circuit, simultaneously adding the plurality of sets of data corresponding to the matching number of channels to generate a plurality of sets of addition data, and performing an average calculation on the plurality of sets of addition data corresponding to the matching number of channels to generate the plurality of sets of pooling data; and
a selection circuit, selecting one of the maximum calculation circuit and the average calculation circuit to perform the pooling process on the plurality of sets of data.

7. The pooling calculation device according to claim 1, wherein the data matrix comprises a plurality of sets of first data corresponding to a first window and a plurality of sets of second data corresponding to a second window, an overlapping part of the data matrix corresponding to the first window and the second window is a plurality of sets of overlapping data, the plurality of sets of overlapping data is simultaneously included in the plurality of sets of first data and the plurality of sets of second data, and the plurality of sets of first intermediate data generated during the pooling calculation process performed by the pooling calculation circuit is stored to the registers; wherein when the pooling calculation circuit performs the pooling calculation on the plurality of sets of second data according to the second window, the pooling calculation circuit performs the pooling calculation by using part of the plurality of sets of first intermediate data stored in the registers corresponding to the plurality of sets of overlapping data.

8. A pooling calculation method, operable to perform a pooling calculation on a data matrix with a plurality of channels, the pooling calculation method applied to an integrated circuit comprising an internal memory and a pooling calculation device, the pooling calculation method comprising:
storing at least part of data of the data matrix to the internal memory; and
reading a plurality of sets of data corresponding to a matching number of channels from the memory by the pooling calculation device, and simultaneously performing a pooling process on the plurality of sets of data corresponding to the matching number of channels by the pooling calculation device to generate a plurality of sets of pooling data corresponding to the matching number of channels;
wherein the matching number of channels are determined according to a bandwidth of the internal memory, and the matching number is a positive integer greater than or equal to 2.

9. The pooling calculation method according to claim 8, wherein the pooling calculation device comprises an average calculation circuit, the average calculation circuit comprises a plurality of adders and a plurality of dividers, and the performing of a pooling process on the plurality of sets of data corresponding to the matching number of channels by the pooling calculation device to generate a plurality of sets of pooling data corresponding to the matching number of channels comprises:
simultaneously performing an addition on the plurality of sets of data respectively corresponding to the matching number of channels by the adders to generate a plurality of sets of addition data; and
simultaneously performing a division on the plurality of sets of addition data corresponding to the matching number of channels by the dividers to generate the plurality of sets of pooling data.

10. The pooling calculation method according to claim 8, wherein the pooling calculation device comprises a maximum calculation circuit, the maximum calculation circuit comprises a plurality of comparators, and the performing of a pooling process on the plurality of sets of data corresponding to the matching number of channels by the pooling calculation device to generate a plurality of sets of pooling data corresponding to the matching number of channels comprises:
simultaneously comparing the plurality of sets of data corresponding to the matching number of channels by the comparators to generate a plurality of sets of maximum data as the plurality of sets of pooling data.
